(19) United States
(12) Patent Application Publication
(10) Pub. No.: US 2022/0101714 A1
(43) Pub. Date: Mar. 31, 2022

(54) CONTROL DEVICE, PROGRAM, AND SYSTEM

(71) Applicant: KABUSHIKI KAISHA TOKAI RIKA DENKI SEISAKUSHO, Aichi (JP)

(72) Inventor: Keita NAKANE, Aichi (JP)

(73) Assignee: KABUSHIKI KAISHA TOKAI RIKA DENKI SEISAKUSHO, Aichi (JP)

(21) Appl. No.: 17/421,904

(22) PCT Filed: Mar. 26, 2020
(86) PCT No.: PCT/JP2020/013706

§ 371 Date: Jul. 9, 2021

(30) Foreign Application Priority Data
Mar. 26, 2019 (JP) 2019-059340
Mar. 26, 2020 (JP) 2020-055975

(51) Int. Cl. G08B 21/18; G08B 3/10; G08B 6/00; G08B 5/36; G06F 3/0484

(52) U.S. Cl. CPC G08B 21/182; G08B 3/10; G06F 3/0484; G08B 5/36; G08B 6/00

(57) ABSTRACT

To improve the operability. There is provided a control device including: a reception unit that receives operation on at least one operation unit, and a control unit that controls a notification unit to perform a notification in accordance with an execution state of a function, in which the control unit controls, when the execution state of the function has become a predetermined specified state on the basis of the operation received by the reception unit, the notification unit to perform a notification in a mode in accordance with the specified state.

### TECHNICAL FIELD

The present invention relates to a control device, a program, and a system.

### BACKGROUND ART

Recently, there have been developed a number of systems adopting a graphical user interface (GUI). For example, Patent Literature 1 discloses a system capable of executing functions corresponding to command input options displayed on a monitor by operating a touch pad.

Moreover, in the system disclosed in Patent Literature 1, an input field corresponding to the above-described command input options is arranged on the touch pad. When a user touches the input field, a user performing an operation is notified, and the function corresponding to the command input option is executed. With such a control, a user can perform a desirable operation without constantly gazing at a monitor.

### CITATION LIST

### Patent Literature

Patent Literature 1: Japanese Patent Application Laid-open No. 2003-108311

### SUMMARY OF INVENTION

### Technical Problem

However, in the above-described system, when the same notification is performed regardless of the execution state of a function varying in accordance with an operation, a user may not be able to grasp the execution state of the function, which may deteriorate the operability.

In view of the above-described problem, the present invention aims at providing a mechanism capable of further improving the operability.

### Solution to Problem

In order to solve the above-described problem, an aspect of the present invention provides a control device including a reception unit that receives an operation on at least one operation unit, and a control unit that controls a notification unit to perform a notification in accordance with an execution state of a function, in which the control unit controls, when the execution state of the function has become a predetermined specified state on the basis of the operation received by the reception unit, the notification unit to perform a notification in a mode in accordance with the specified state.

Moreover, in order to solve the above-described problem, another aspect of the present invention provides a program controlling a computer to achieve a reception function for receiving an operation on at least one operation unit, and a control function for controlling a notification unit to perform a notification in accordance with an execution state of a function, in which the control function controls, when the execution state of the function has become a predetermined specified state on the basis of the operation received by the reception function, the notification unit to perform a notification in a mode in accordance with the specified state.

Moreover, in order to solve the above-described problem, another aspect of the present invention provides a system, including at least one operation unit, a reception unit that receives an operation on the operation unit, a notification unit that performs a notification to a user performing an operation, and a control unit that controls the notification unit to perform a notification in accordance with an execution state of a function, in which the control unit controls, when the execution state of the function has become a predetermined specified state on the basis of the operation received by the reception unit, the notification unit to perform a notification in a mode in accordance with the specified state.

### Advantageous Effects of Invention

According to the present invention, it is possible to further improve the operability.

### BRIEF DESCRIPTION OF DRAWINGS

FIG. 1 is a diagram illustrating a functional configuration example of a system 1 according to an embodiment of the present invention.

FIG. 2 is a diagram illustrating an example of notification control in accordance with a first state according to the embodiment.

FIG. 3 is a diagram illustrating an example of notification control in accordance with a second state according to the embodiment.

FIG. 4 is a diagram illustrating an example of notification control in accordance with a third state according to the embodiment.

FIG. 5A is a diagram illustrating an example of an operation unit 110 according to the embodiment.

FIG. 5B is a diagram illustrating an example of the operation unit 110 according to the embodiment.

FIG. 5C is a diagram illustrating an example of the operation unit 110 according to the embodiment.

FIG. 6 is a diagram for explaining a parameter variation amount and notification control in accordance with a mode of an operation according to the embodiment.

FIG. 7 is a flowchart illustrating an example of a flow of actions of a control device 40 according to the embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference signs, and repeated explanation thereof is omitted.

### Embodiments

### <<Configuration Example>>

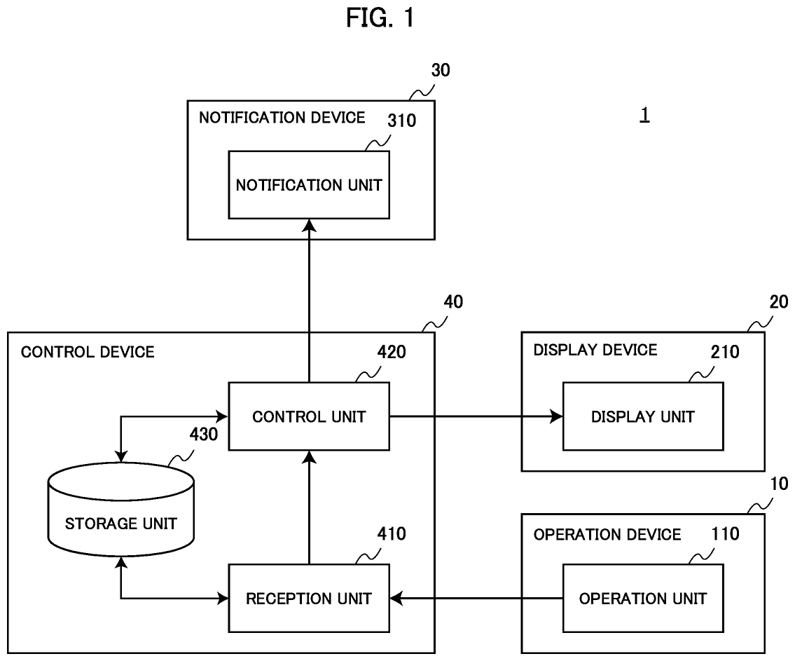

First, there will be described a configuration example of the system 1 according to an embodiment of the present invention. FIG. 1 is a diagram illustrating a functional configuration example of the system 1 according to the embodiment. As illustrated in FIG. 1, the system 1 of the embodiment includes, for example, an operation device 10, a display device, 20, a notification device 30, and a control device 40.

### (Operation Device 10)

The operation device 10 of the embodiment is a device that is a target on which a user performs operations. The system 1 of the embodiment may include at least one or more operation devices 10. The operation device 10 of the embodiment may be, for example, a touch pad, a track ball, a mouse, a wheel, a slide switch, a dial, or the like. The operation device 10 of the embodiment includes an operation unit 110.

The operation unit 110 of the embodiment includes a function of detecting user's operation. For this, the operation unit 110 may include various detection mechanisms in accordance with the modes of the operation device 10. For example, in a case where the operation device 10 is a touch pad, the operation unit 110 may include a pressure sensitive sensor converting a pressure varying with user's operation into electric signals, or an electrostatic capacitance sensor converting a change of an electrostatic capacity varying with user's operation into electric signals. Moreover, the operation unit 110 may include a switch for detecting a push operation by a user. The operation unit 110 transmits detected signals related to user's operation to the control device 40.

### (Display Device 20)

The display device 20 of the embodiment is a device that displays visual information such as an image. The display device 20 of the embodiment may be various kinds of display devices. The display device 20 of the embodiment includes a display unit 210.

The display unit 210 of the embodiment may display images on the basis of signals input from the control device 40.

### (Notification Device 30)

The notification device 30 of the embodiment is a device that performs various notifications to a user in accordance with the control by the control device 40. The notification device 30 of the embodiment includes a notification unit 310.

The notification unit 310 of the embodiment performs a notification based on control signals input from the control device 40. For this, the notification unit 310 includes various output mechanisms in accordance with the modes of notifications. For example, in the case of performing a notification using the tactile perception of a user, the notification unit 310 may include various kinds of actuators capable of generating vibration stimulations, electric stimulations, pressing stimulations, warm/cold stimulations, or the like. For example, in the case of performing a notification using vibration stimulations, the notification unit 310 may include an eccentric rotating mass (ERM), a linear resonant actuator (LRA), or a piezo (electric) element, a voice coil motor, or the like. Moreover, the notification unit 310 may include a plurality of actuators of the same kind or different kinds.

Moreover, for example, in the case of performing a notification using the auditory sense of a user, the notification unit 310 may include a speaker or an amplifier. Moreover, for example, in the case of performing a notification using the visual sense of a user, the notification unit 310 may include various kinds of lighting emitting light.

Note that the notification by the notification unit 310 may be performed using the combination of a plurality of different kinds of stimulations. For example, the notification unit 310 may perform a notification using vibrations and sound. Moreover, for example, the notification unit 310 may perform a notification using electric stimulations and light. The notification unit 310 of the embodiment performs a notification using at least one of vibrations, sound, and light, on the basis of the control by the control device 40.

### (Control Device 40)

The control device 40 of the embodiment is a device that receives user's operation on the operation device 10 and performs a control in accordance with the operation. The control device 40 of the embodiment includes a reception unit 410, a control unit 420, and a storage unit 430.

The reception unit 410 of the embodiment has a function of receiving an operation on at least one operation unit 110. For example, the reception unit 410 receives electric signals generated by the operation unit 110 on the basis of the detected user's operation, and receives an operation in accordance with the electric signals.

The control unit 420 of the embodiment performs various kinds of controls in accordance with the contents of the operation received by the reception unit 410. The control unit 420 of the embodiment may change the execution state of a given function on the basis of the operation received by the reception unit 410, for example.

Moreover, the control unit 420 of the embodiment may control the notification unit 310 to perform a notification in accordance with the execution state of the above-described function.

The function of the control unit 420 is achieved by the cooperation of a processor such as a central processing unit (CPU), a random access memory (RAM), and the like, for example. The notification control by the control unit 420 of the embodiment will be separately described in detail.

The storage unit 430 of the embodiment stores various kinds of information related to the actions of the control device 40. The storage unit 430 stores, for example, programs and the like for notification processing performed by the control unit 420.

The above has described the functional configuration example of the system 1 of the embodiment. Note that the functional configuration using FIG. 1 is an example, and the functional configuration of the system 1 of the embodiment is not limited thereto. For example, the operation device 10 and the notification device 30 may be formed as an integrated device. In this case, a notification using vibration stimulations is performed, for example, whereby it is possible to achieve a notification as a feedback to user's operation on the operation device 10. The functional configuration of the system 1 of the embodiment can be modified flexibly depending on specifications and uses.

### <<Details>>

The following will specifically describe the functions of the system 1 according to the embodiment. Note that the following supposes, as a main example, a case where the system 1 of the embodiment is applied to a vehicle interior of a mobile body such as a vehicle. For example, at least one or more operation units 110 may be provided at a spoke of a steering. Moreover, the notification unit 310 may be formed integrally with the operation unit 110, and perform a notification using vibration stimulations. Moreover, the display unit 210 may be provided as (a part of) an instrument panel, or provided at a center console.

Here, it is supposed that a user operates the operation unit 110 and changes the execution state of a function of the system 1. The above-described function may have a plurality of stages regarding the execution state. Examples of such a function include, for example, a function of adjusting a temperature or air quantity of air conditioning, a function of adjusting a volume of an audio, and the like.

When the above-described operation is performed, and if the execution state of a function varying in accordance with an operation is not displayed on the display unit 210, for example, it is difficult for a user to determine whether the execution state of the function has become a desired execution state by user's own operation.

Moreover, even in a case where the execution state of the function is displayed on the display unit 210, if a user does not gaze at the display 210, it is difficult to determine whether the execution state of the function has become a desired execution state.

The technical ideas of the present invention have been made in view of the above-described aspects, and further improve the operability. For this, the control unit 420 according to one embodiment of the present invention is characterized in controlling, when the execution state of a function has become a predetermined specified state on the basis of an operation received by the reception unit 410, the notification unit 310 to perform a notification in a mode in accordance with the specified state.

With the above-described control by the control unit 420 of the embodiment, a user can intuitively grasp the fact that the execution state of the function has become the specified state by user's own operation.

Moreover, when the execution state of the function has become a state other than the specified state on the basis of an operation received by the reception unit 410, the control unit 420 of the embodiment may control the notification unit 310 to perform a notification of a mode different from the mode in accordance with the specified state (hereinafter, also referred to as a normal notification).

With the above-described control by the control unit 420 of the embodiment, a user can grasp more clearly the fact that the execution state of the function has shifted between the specified state and the state other than the specified state by user's own operation.

The following will describe concrete examples in detail. The specified state of the embodiment may include the first state where a parameter related to the execution of a function is equal to an upper limit value. Here, the above-described parameter may be a value defining the above-described plurality of stages.

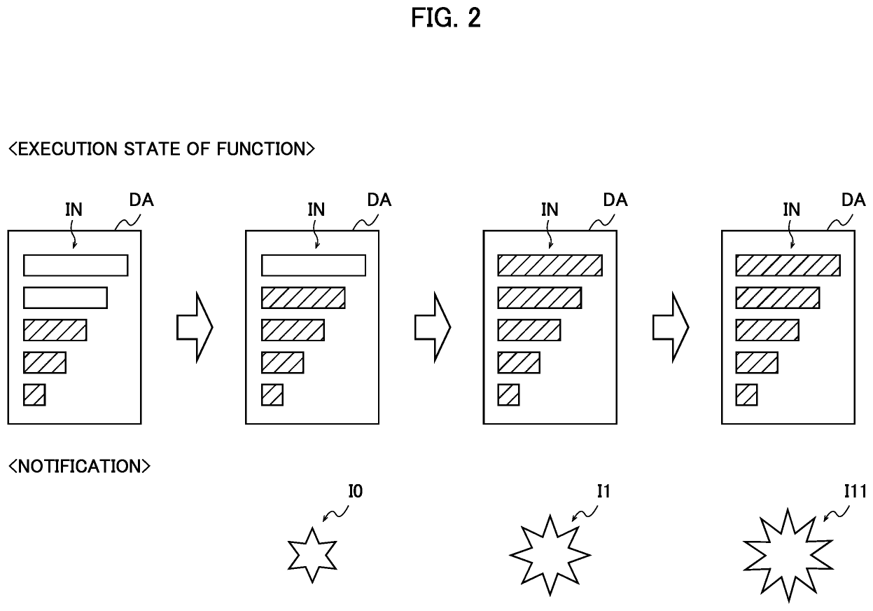

FIG. 2 is a diagram illustrating an example of notification control in accordance with the first state according to the embodiment. Note that FIG. 2 illustrates the air quantity of air conditioning as an example of the execution state of a function varying in accordance with user's operation. Moreover, FIG. 2 schematically illustrates, in the upper stage thereof, indicators IN indicating the strength of air quantity displayed on a display area DA of the display unit 210, and schematically illustrates, in the lower stage thereof, notifications output by the notification unit 310 under the control of the control unit 420 in accordance with the change of the strength of air quantity.

Moreover, FIG. 2 exemplifies a case where the parameter related to the strength of air quantity changes by 1 per time from 1 that is a lower limit value to 5 that is an upper limit value. For example, in the case of an example illustrated in the first column from the left in the drawing, the indicator IN emphasizes, among five rectangles, the lower three rectangles for display. This indicates that the above-described parameter is “3”.

When the user operates the operation unit 110 from this state, and the above-described parameter is changed to “4” on the basis of the operation, the control unit 420 changes the air quantity of air conditioning to the strength corresponding to the parameter “4”, and changes the indicator IN to the state where the lower four rectangles are emphasized among five rectangles, as illustrated in the second column from the left in the drawing.

Moreover, here, the control unit 420 of the embodiment controls, on the basis of the fact that the strength of air quantity is in a state other than the specified state (first state), the control unit 310 to perform a normal notification I0 that is a notification in a mode in accordance with the state other than the specified state.

When the user further operates the operation unit 110 from this state, and the above-described parameter is changed to “5” that is the upper limit value, on the basis of the operation, the control unit 420 changes the air quantity of air conditioning to the strength corresponding to the parameter “5”, and changes the indicator IN to the state where all of the five rectangles are emphasized, as illustrated in the third column from the left in the drawing.

Moreover, here, on the basis of the fact that the parameter has become equal to the upper limit value, that is, the strength of air quantity has become the first state, the control unit 420 of the embodiment controls the control unit 310 to perform a first notification I1 that is a notification in a mode in accordance with the first state. The first notification I1 may be a notification in a mode different from the normal notification I0.

With the above-described control by the control unit 420 of the embodiment, the user can intuitively grasp the fact that the parameter related to the execution of the function has reached the upper limit value, that is, the stage of the execution state of the function has reached the maximum by user's own operation.

Moreover, when the execution state of the function is the first state, and the operation for ordering the increase of the parameter has been received by the reception unit 410, the control unit 420 of the embodiment may control the notification unit 310 to perform a notification in a mode indicating that the first state is continued (hereinafter, also referred to as a continuance notification related to the first state).

For example, when the user performs an operation for further increasing the air quantity from the state of the third column from the left illustrated in FIG. 2, the control unit 420 controls the notification unit 310 to perform the continuance notification I11 related to the first state, which is different from the normal notification I0 and the first notification I1, as illustrated in the fourth column from the left.

With the above-described control by the control unit 420 of the embodiment, it is possible to allow a user to perceive that the parameter has already reached the upper limit value, and prevent the user from continuously performing unnecessary operations.

The above has illustrated an example regarding the notification control in accordance with the first state of the embodiment. Meanwhile, the specified state of the embodiment is not limited to the first state. The specified state of the embodiment may include a second state where the parameter related to the execution of a function is equal to the lower limit value.

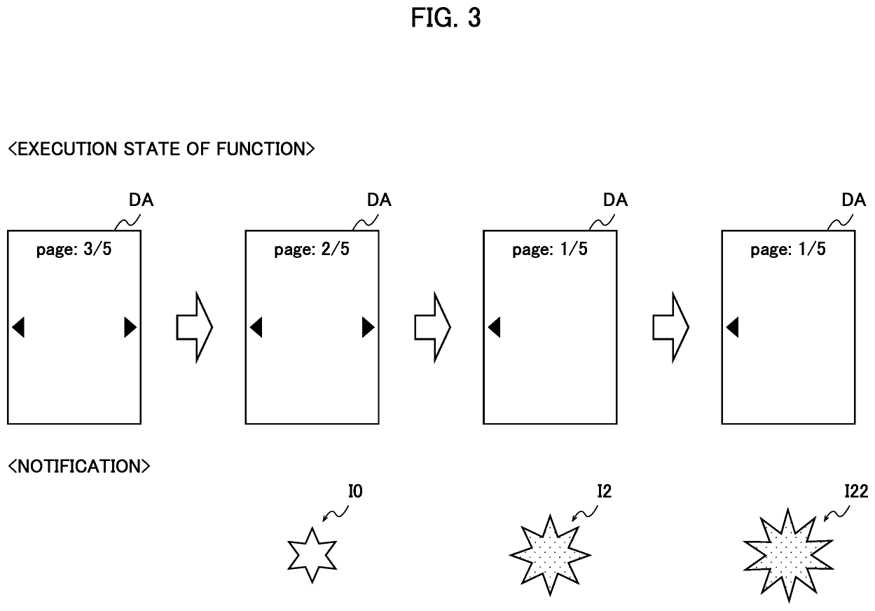

FIG. 3 is a diagram illustrating an example of notification control in accordance with the second state according to the embodiment. Note that FIG. 3 illustrates a shift of pages displayed on the display area DA as an example of the execution state of a function varying in accordance with user's operation. FIG. 3 schematically illustrates, in the upper stage thereof, pages displayed on the display area DA of the display unit 210, and schematically illustrates, in the lower stage thereof, notifications output by the notification unit 310 under the control of the control unit 420 in accordance with the change of a displayed page.

For example, in the case of an example illustrated in the first column from the left in the drawing, the display area DA displays the third page among five pages in total. Note that in FIG. 3, the parameter related to the execution of a function corresponds to the number of pages.

When the user operates the operation unit 110 from this state, and the parameter is changed to “2” on the basis of the operation, the control unit 420 performs a control so that the second page is displayed on the display area DA, as illustrated in the second column from the left in the drawing.

Moreover, here, the control unit 420 of the embodiment controls, on the basis of the fact that the second page displayed on the display area DA is a page corresponding to a state other than the specified state (second state), the control unit 310 to perform the normal notification I0 that is a notification in a mode in accordance with a state other than the specified state.

When the user further operates the operation unit 110 from this state, and the parameter is changed to “1” that is the lower limit value, on the basis of the operation, the control unit 420 performs a control so that the first page is displayed on the display area DA, as illustrated in the third column from the left in the drawing.

Moreover, here, on the basis of the fact that the parameter has become equal to the lower limit value, that is, the page displayed on the display area DA has become the second state, the control unit 420 of the embodiment controls the control unit 310 to perform the second notification I2 that is a notification in the mode in accordance with the second state. The second notification I2 may be a notification in a mode different from the normal notification I0.

With the above-described control by the control unit 420 of the embodiment, the user can intuitively grasp the fact that the parameter related to the execution of the function has reached the lower limit value, that is, the stage of the execution state of the function has reached the minimum by user's own operation.

Moreover, when the execution state of the function is the second state, and the operation for ordering the reduction of the parameter has been received by the reception unit 410, the control unit 420 of the embodiment may control the notification unit 310 to perform a notification in a mode indicating that the second state is continued (hereinafter, also referred to as a continuance notification related to the second state).

For example, when the user performs an operation for further returning pages from the state of the third column from the left illustrated in FIG. 3, the control unit 420 controls the notification unit 310 to perform the continuance notification I22 related to the second state, which is different from the normal notification I0 and the second notification I2, as illustrated in the fourth column from the left.

With the above-described control by the control unit 420 of the embodiment, it is possible to allow a user to perceive that the parameter has already reached the lower limit value, and prevent the user from continuously performing unnecessary operations.

The following will describe a third state of the embodiment. The specified state of the embodiment may include the third state that is different from the first state and the second state described above. The third state of the embodiment may be, for example, a state where the parameter related to the execution of a function is equal to a predetermined reference value (default value), an intermediate value that is a value between an upper limit value and a lower limit value, a setting value arbitrarily set by a user, or the like.

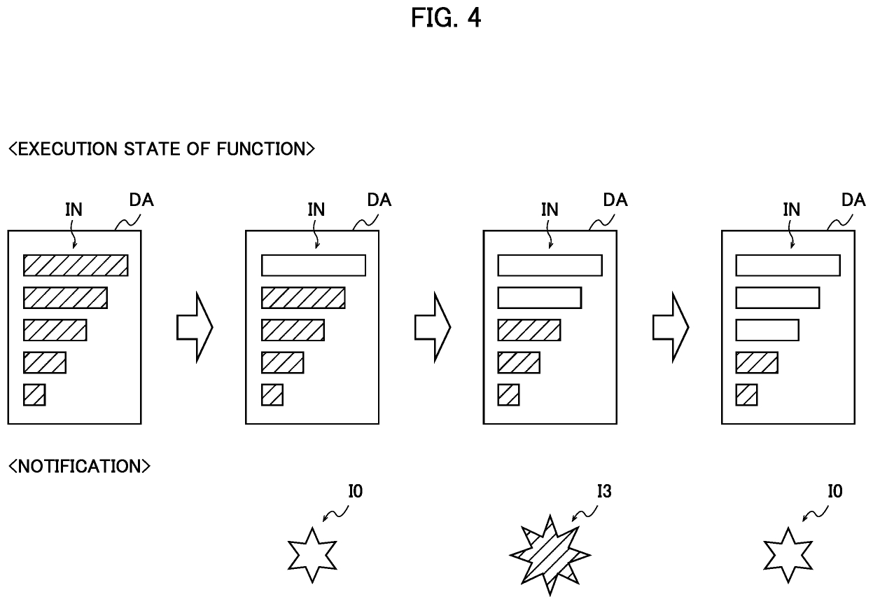

FIG. 4 is a diagram illustrating an example of notification control in accordance with the third state according to the embodiment. Note that FIG. 4 illustrates the air quantity of air conditioning as an example of the execution state of a function varying in accordance with user's operation, similarly to the example illustrated in FIG. 2. Moreover, FIG. 4 illustrates, as the third state, the state where the parameter related to the execution of the function is equal to an intermediate value “3” that is a value between the upper limit value “5” and the lower limit value “1”.

For example, when the user operates the operation unit 110 from the state illustrated in the first column from the left in the drawing, and the above-described parameter is changed to “4” on the basis of the operation, the control unit 420 changes the air quantity of air conditioning to the strength corresponding to the parameter “4”, and changes the indicator IN to the state where the lower four rectangles are emphasized among five rectangles, as illustrated in the second column from the left in the drawing.

Moreover, here, the control unit 420 of the embodiment controls, on the basis of the fact that the strength of air quantity is in a state other than the specified state (third state), the control unit 310 to perform the normal notification I0 that is a notification in a mode in accordance with the state other than the specified state.

When the user further operates the operation unit 110 from this state, and the above-described parameter is changed to “3” that is an intermediate value, on the basis of the operation, the control unit 420 changes the air quantity of air conditioning to the strength corresponding to the parameter “3”, and changes the indicator IN to the state where the lower three rectangles are emphasized among five rectangles, as illustrated in the third column from the left in the drawing.

Moreover, here, on the basis of the fact that the parameter has become equal to the intermediate value, that is, the strength of air quantity has become the third state, the control unit 420 of the embodiment controls the control unit 310 to perform the third notification I3 that is a notification in a mode in accordance with the third state. The third notification I3 may be a notification in a mode different from the normal notification I0.

With the above-described control by the control unit 420 of the embodiment, the user can intuitively grasp the fact that the parameter related to the execution of the function has reached the specified value such as an intermediate value, that is, the stage of the execution state of the function has reached the specified stage by user's own operation.

Note that when the user performs an operation for further reducing the air quantity from the state of the third column from the left in FIG. 4, the control unit 420 may control, on the basis of the fact that the strength of air quantity has become a state other than the specified state again, the notification unit 310 to perform the normal notification I0, as illustrated in the fourth column from the left.

The above has described the first to third states of the embodiment, and the notification control in accordance with each of the states using the concrete examples. As described above, the control unit 420 of the embodiment performs a notification of each state by a mode different from the other states, thereby allowing a user to intuitively grasp the execution state of a function.

Note that the control unit 420 can control the notification unit 310 to perform a notification in the above-described mode in accordance with each state by controlling the strength, time, number of times, and the like of the notification. For example, when the notification unit 310 is controlled to perform a notification using vibration stimulations, the control unit 420 controls the amplitude, frequency, time, number of times, and the like of vibrations, thereby achieving the notification in a mode different for each state.

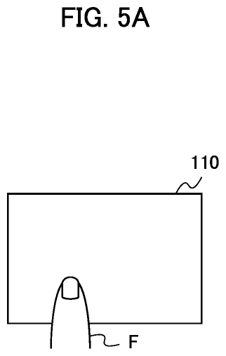

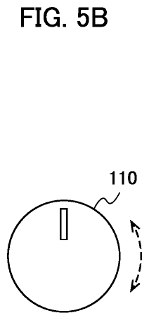

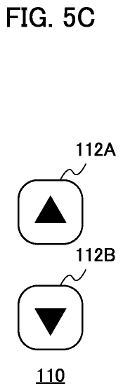

The following will describe the form of the operation unit 110 of the embodiment using concrete examples. The operation unit 110 of the embodiment can be in a variety of forms depending on characteristics of a function to be controlled. FIG. 5A to FIG. 5C are diagrams each illustrating an example of the operation unit 110 according to the embodiment.

For example, the operation unit 110 of the embodiment may be provided as a touch pad to be operated by a user using the finger F or the like, as illustrated in FIG. 5A. In this case, the user may be able to increase or reduce the parameter related to the execution of a function by sliding the finger F vertically or laterally, for example.

Moreover, for example, the operation unit 110 of the embodiment may be provided as a dial that can be turned clockwise and counterclockwise, as illustrated in FIG. 5B. In this case, the user may be able to increase or reduce the parameter related to the execution of a function by turning the dial.

Moreover, for example, the operation unit 110 of the embodiment may include two buttons 112A and 112B, as illustrated in FIG. 5C. In this case, the user may be able to increase the parameter related to the execution of a function by pressing the button 112A and reduce the parameter by pressing the button 112B, for example.

The above has described the concrete examples regarding the operation unit 110 of the embodiment. The control unit 420 of the embodiment can control the execution state of a function and a notification in accordance with such an execution state, on the basis of the operations described above.

Moreover, the control unit 420 of the embodiment may change a variation amount of the parameter related to the execution of a function, in accordance with a mode of an operation received by the reception unit 410. Moreover, here, the control unit 420 of the embodiment may control the control unit 310 to perform a notification in a mode in accordance with the variation amount.

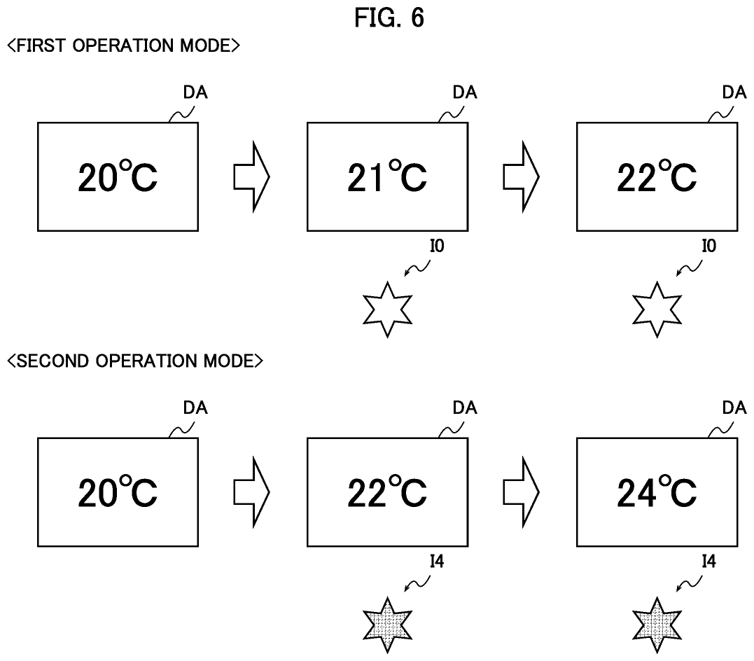

FIG. 6 is a diagram for explaining a parameter variation amount and notification control in accordance with a mode of an operation according to the embodiment. FIG. 6 illustrates, in the upper stage thereof, an example of the control when the operation in the first operation mode is performed, and illustrates, in the lower stage thereof, an example of the control when the operation in the second operation mode different from the first operation mode is performed. Note that FIG. 6 illustrates a temperature of air conditioning as an example of the parameter related to the execution of a function.

For example, as illustrated in the upper stage of the drawing, when the operation in the first operation mode has been performed, the control unit 420 of the embodiment may set a variation amount of the parameter so that the temperature changes by 1° C. per time. Moreover, in this case, the control unit 420 may control the notification unit 310 to perform the notification I0 in the mode in accordance with the above-described set variation amount.

Meanwhile, as illustrated in the lower stage of the drawing, when the operation in the second operation mode has been performed, the control unit 420 of the embodiment may set a variation amount of the parameter so that the temperature changes by 2° C. per time. Moreover, in this case, the control unit 420 may control the notification unit 310 to perform a notification I4 in the mode in accordance with the above-described set variation amount.

With the above-described control by the control unit 420 of the embodiment, the user can instinctively grasp the variation amount of the parameter varying in accordance with an operation mode, which further improve the operability.

Note that the above-described first operation mode and second operation mode may be set in accordance with the characteristics of the operation unit 110. For example, in a case where the operation unit 110 is provided as a touch pad as illustrated in FIG. 5A, the first operation mode may be a mode in which the operation is performed using one finger F, and the first operation mode may be a mode in which the operation is performed using two fingers F.

Moreover, for example, in a case where the operation unit 110 is provided as a dial as illustrated in FIG. 5B, the first operation mode may be a mode in which the operation unit 110 is operated at a rotational speed smaller than a threshold, and the second operation mode may be a mode in which the operation unit 110 is operated at a rotational speed equal to or larger than a threshold.

Moreover, for example, in a case where the operation unit 110 includes the button 112 as illustrated in FIG. 5C, the first operation mode may be a mode in which the time for pressing the button 112 is shorter than a threshold, and the second operation mode may be a mode in which the time for pressing the button 112 is equal to or longer than a threshold.

As described above, the control method of the embodiment can be widely applied regardless of the form of the operation unit 110.

Moreover, the operation of the embodiment is not limited to the operation related to the adjustment of air quantity or temperature, or the shift of pages, as described above.

Other examples of the operation of the embodiment include, for example, a pinch-out operation for enlarging an image displayed on the display area DA, and a pinch-in operation for reducing an image. In this case, the first state may be, for example, a state where the enlargement ratio that is a parameter is maximum, and the second state may be, for example, a state where the reduction ratio that is a parameter is minimum.

Moreover, the operation of the embodiment may be an operation related to character input. For example, there is supposed the graphical user interface (GUI) in which an input character is changed in the order of “A”, “I”, “U”, “E”, and “O” in accordance with an operation performed on the operation unit 110. In this case, the first state may be a state where “A” is selected as an input character, and the second state may be a state where “O” is selected as an input character.

The control method according to the embodiment can be widely applied to various kinds of operation input systems including various operation units 110.

### <Flow of Control>

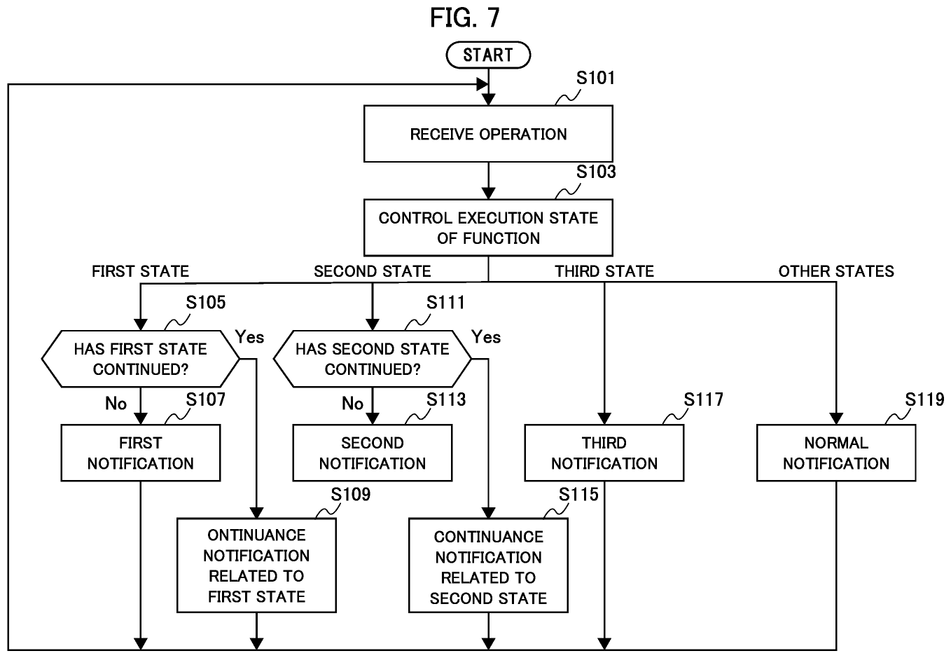

The following will specifically describe a flow of control by the control device 40 according to the embodiment. FIG. 7 is a flowchart illustrating an example of a flow of actions of the control device 40 according to the embodiment.

As illustrated in FIG. 7, the reception unit 410 first receives user's operation performed on the operation unit 110 (S101). The reception unit 410 receives the operation on the basis of signals input from the operation unit 110, and inputs information related to the operation to the control unit 420.

Next, the control unit 420 controls the execution state of a given function on the basis of the operation received by the reception unit 410 at Step S101 (S103).

Moreover, here, the control unit 420 may set a variation amount of the parameter in accordance with an operation mode and a notification mode in accordance with the variation amount.

Next, the control unit 420 performs a notification control in accordance with the execution state of the function varied by the control at Step S103.

For example, in a case where the execution state of the function is the first state after the control at S103, the control unit 420 determines whether the first state has continued since before the control at S103 (S105).

Here, when the first state has not continued since before the control at S103 (No at S105), that is, when the execution state of the function has shifted to the first state by the control at S103, the control unit 420 controls the notification unit 310 to perform the first notification in a mode in accordance with the first state (S107).

Meanwhile, when the first state has continued since before the control at S103 (Yes at S105), the control unit 420 controls the notification unit 310 to perform a continuance notification related to the first notification (S109).

Moreover, in a case where the execution state of the function is the second state after the control at S103, the control unit 420 determines whether the second state has continued since before the control at S103 (S111).

Here, when the second state has not continued since before the control at S103 (No at S111), that is, when the execution state of the function has shifted to the second state by the control at S103, the control unit 420 controls the notification unit 310 to perform the second notification in a mode in accordance with the second state (S113).

Meanwhile, when the second state has continued since before the control at S103 (Yes at S111), the control unit 420 controls the notification unit 310 to perform a continuance notification related to the second notification (S115).

Moreover, in a case where the execution state of the function is the third state after the control at S103, the control unit 420 controls the notification unit 310 to perform the third notification in a mode in accordance with the third state (S117).

Moreover, in a case where the execution state of the function is a state other than the first to third states after the control at S103, the control unit 420 controls the notification unit 310 to perform the normal notification in a mode in accordance with the state other than the first to third states (S119).

After the notification control at any one of Steps S107, S109, S113, S115, S117, and S119, the control device 40 may return to Step S101 and repeatedly perform the subsequent processing until the stop of the function is ordered.

### <Supplement>

Heretofore, preferred embodiments of the present invention have been described in detail with reference to the appended drawings, but the present invention is not limited thereto. It is obvious that a person skilled in the art can arrive at various alterations or modifications within the scope of the technical ideas defined in the claims, and it should be naturally understood that such alterations and modifications are also encompassed by the technical scope of the present invention.

Moreover, a sequence of processing by the devices described in the specification may be achieved using any one of software, hardware, and the combination of software and hardware. A program forming the software is preliminarily stored in a non-transient storage medium provided inside or outside the devices, for example. Then, each program is read in a random access memory (RAM) when executed by a computer, and executed by a processor such as a central processing unit (CPU). The above-described storage medium is, for example, a magnetic disk, an optical disk, a magneto-optical disk, a flash memory, or the like. Moreover, the above-described computer program may be distributed through a network, for example, without using any storage medium.

### REFERENCE SIGNS LIST

1 system
10 operation device
110 operation unit
20 display device
210 display unit
30 notification device
310 notification unit
40 control device
410 reception unit
420 control unit
430 storage unit

1. A control device, comprising:
a reception unit that receives an operation on at least one operation unit; and
a control unit that controls a notification unit to perform a notification in accordance with an execution state of a function, wherein
the control unit controls, when the execution state of the function has become a predetermined specified state on the basis of the operation received by the reception unit, the notification unit to perform a notification in a mode in accordance with the specified state.

2. The control device according to claim 1, wherein the control unit controls, when the execution state of the function based on the operation received by the reception unit is a state other than the specified state, the notification unit to perform a notification in a mode different from the mode in accordance with the specified state.

3. The control device according to claim 1, wherein the specified state includes at least a first state where a parameter related to the execution of the function is equal to an upper limit value and a second state where the parameter is equal to a lower limit value, and
the control unit controls, when the execution state of the function has become the first state on the basis of the operation received by the reception unit, the notification unit to perform a notification in a mode in accordance with the first state, and controls, when the execution state of the function has become the second state on the basis of the operation received by the reception unit, the notification unit to perform a notification in a mode in accordance with the second state.

4. The control device according to claim 3, wherein the control unit controls, when the execution state of the function is the first state and an operation for ordering an increase of the parameter has been received by the reception unit, the notification unit to perform a notification in a mode indicating that the first state is continued, and controls, when the execution state of the function is the second state and an operation for ordering reduction of the parameter has been received by the reception unit, the notification unit to perform a notification in a mode indicating that the second state is continued.

5. The control device according to claim 3, wherein the specified state includes a third state that is different from the first state and the second state, and
the control unit controls, when the execution state of the function has become the third state on the basis of the operation received by the reception unit, the notification unit to perform a notification in a mode in accordance with the third state.

6. The control device according to claim 5, wherein the third state includes a state where the parameter is equal to at least one of a predetermined reference value, an intermediate value that is a value between an upper limit value and a lower limit value, and a setting value set by a user.

7. The control device according to claim 3, wherein the control unit changes a variation amount of the parameter in accordance with a mode of the operation received by the reception unit, and controls the notification unit to perform a notification in a mode in accordance with the variation amount.

8. The control device according to claim 1, wherein the control unit controls the control unit to perform a notification using at least one of vibrations, sound, and light.

9. A non-transitory computer readable storage medium having a program stored therein, the program controlling a computer to achieve:
a reception function for receiving an operation on at least one operation unit; and
a control function for controlling a notification unit to perform a notification in accordance with an execution state of a function, wherein
the control function controls, when the execution state of the function has become a predetermined specified state on the basis of the operation received by the reception function, the notification unit to perform a notification in a mode in accordance with the specified state.

10. A system, comprising:
at least one operation unit;
a reception unit that receives an operation on the operation unit;
a notification unit that performs a notification to a user performing an operation; and
a control unit that controls the notification unit to perform a notification in accordance with an execution state of a function, wherein
the control unit controls, when the execution state of the function has become a predetermined specified state on the basis of the operation received by the reception unit, the notification unit to perform a notification in a mode in accordance with the specified state.
